(19) United States
(12) Patent Application Publication
(10) Pub. No.: US 2020/0189673 A1
(43) Pub. Date: Jun. 18, 2020

(54) CRAWLER TRACK, IN PARTICULAR RUBBER CRAWLER TRACK

(71) Applicant: ContiTech Transportbandsysteme GmbH, Hannover (DE)

(72) Inventors: Achim Huels, Barsinghausen (DE); Carsten Behrens, Bilshausen (DE)

(73) Assignee: ContiTech Transportbandsysteme GmbH, Hannover (DE)

(21) Appl. No.: 16/471,405

(22) PCT Filed: Oct. 19, 2017
(86) PCT No.: PCT/EP2017/076653

§ 371 Date: Jun. 19, 2019

(30) Foreign Application Priority Data
Dec. 19, 2016 (DE) 10 2016 225 396.4

(51) Int. Cl. B62D 55/26; B62D 55/24

(52) U.S. Cl. CPC B62D 55/26; B62D 55/244

(57) ABSTRACT

The present invention relates to a caterpillar track (2), in particular a rubber caterpillar track (2), with a track body (20) and with at least one outer profiling element (22), preferably with a plurality of outer profiling elements (22), which are directed outwardly away from the track body (20). The caterpillar track (2) is characterized in that the outer profiling element (22) has an outwardly directed grouser body (23) and a grouser root (24), which connects the grouser body (23) to the track body (20), wherein the grouser body (23) and the grouser root (24) comprise different materials, preferably consist of different materials.

The present invention relates to a caterpillar track, in particular a rubber caterpillar track, according to the preamble of patent claim 1.

Known drive mechanisms for land vehicles include caterpillar tracks. These may be used not only in the military sector but also for agricultural vehicles and for other vehicles for transportation on rough terrain. Caterpillar tracks usually have on their inside, preferably in the center, inwardly projecting tooth elements, by means of which the caterpillar track can be engaged and propelled by a drive wheel or the like of the vehicle. On their outside, caterpillar tracks usually have a profiling to allow them to find better traction on the underlying surface. This profiling may be realized similarly to a tractor tire, for example, that is to say the profiling may for example have bar-like radial elevations which are arranged on the caterpillar track obliquely with respect to its running direction. The inner-lying tooth elements and the outer-lying profiling elements are usually connected by a caterpillar track body which is of an endlessly closed form.

Caterpillar tracks may be produced from rubber, and are therefore referred to as rubber caterpillar tracks. Caterpillar tracks may be produced so as to be of an endlessly closed or open form. They may have a tension member for transmitting tensile forces, for example in the form of steel cables, which may be arranged so as to run around several times in the running direction. There may be transverse reinforcements, which can assist in transmitting the forces across the width of the caterpillar track. The tension members and/or transverse reinforcements are usually enclosed in the caterpillar track body, for example are vulcanized in.

To produce rubber caterpillar tracks, it is known for example from EP 1 075 385 B1 to place unvulcanized rubber elements, which are intended to later form the internal teeth of the rubber caterpillar track, into corresponding apertures of a cylindrical inner mold. The caterpillar track body of the same unvulcanized rubber, with tension members embedded therein, is then applied, for example by winding, over the unvulcanized internal teeth or the outer surface of the inner mold. The caterpillar track body is in this case of such a thick construction in the radially outward direction that the outer profiling can be formed from the radially outer unvulcanized material. This is performed by a cylindrical outer mold, which on its inside has the outer contour of the profiling, and the unvulcanized rubber caterpillar track being pressed against one another, such that the outer-lying unvulcanized material is deformed to form the profiling. The vulcanization is then performed within the press.

During the production of a rubber caterpillar track as per EP 1 135 248 B1, the internal teeth are formed as unvulcanized rubber elements and placed into the corresponding apertures of a cylindrical inner mold. The remaining body of the rubber caterpillar track is constructed separately in an unvulcanized form from the same rubber and then placed onto the inner mold. By pressing the inner mold and outer mold together, the internal teeth are pressed against the body of the rubber caterpillar track from the inside, and the outer shaped segments are formed on the outside of the rubber caterpillar track by pressure. The vulcanization is then performed within the press. The inner mold and the outer mold are in this case of a segmented construction, wherein the segments are initially arranged spaced apart from one another in the circumferential direction and, during the course of the vulcanization, are pressed together so as to produce a cylindrical closed shape.

DE 10 2015 205 071 A1 discloses a method for producing rubber caterpillar tracks in which first unvulcanized shaped elements, which are intended to form the internal teeth of the rubber caterpillar track, are introduced into the corresponding apertures of a mandrel of an inner mold. After that, an unvulcanized body of the rubber caterpillar track with tension members is applied to the shaped elements for internal teeth and to the radial outside of the mandrel. Furthermore, unvulcanized shaped elements of the same rubber material, which are intended to form the external teeth of the rubber caterpillar track, are introduced into corresponding apertures of the outer mold. Subsequently, the inner mold and the outer mold are joined together and the body of the rubber caterpillar track with the shaped elements for internal teeth and with the shaped elements for external teeth is vulcanized. In this way, rubber caterpillar tracks with tension members can be produced easily and cost-effectively without displacement of the tension members being able to occur during production. At least the displacement of the tension members can be reduced.

With all known rubber caterpillar tracks and the methods for producing them, it may be disadvantageous that the outwardly facing profiling or the external teeth, which may also be referred to as grousers, can be subjected to different types of loading. For instance, the outsides of the outwardly facing profiling or of the external teeth, i.e. the grouser bodies, may be exposed to considerable abrasion due to contact with the underlying surface, and so greatest possible abrasion resistance may be advantageous here. Furthermore, the grousers are usually intended to have the best possible grip with the underlying surface. The inner bodies, i.e. the grouser roots, of the outwardly facing profiling or of the external teeth, however, are usually subjected to very dynamic loading. Therefore, least-possible heat build-up, great dynamic strength and good bonding to the layers of material lying further inward may be advantageous at this location.

These requirements are at least partially conflicting, and so it is always necessary to find a compromise between these requirements for the material of the grousers. This may lead to an only insufficient lifetime of the outwardly facing profiling or the external teeth of caterpillar tracks.

An object of the present invention is to provide a caterpillar track, in particular a rubber caterpillar track, of the type described at the beginning having a longer lifetime of the outwardly facing profiling or of the external teeth than has previously been known. At least, an alternative to known caterpillar tracks, and in particular to known rubber caterpillar tracks, with outwardly facing profiling or with external teeth is to be provided.

The object is achieved according to the invention by a caterpillar track, and in particular by a rubber caterpillar track, with the features according to patent claim 1. Advantageous refinements are described in the dependent claims.

Consequently, the present invention relates to a caterpillar track, in particular a rubber caterpillar track, with a track body and with at least one outer profiling element, preferably with a plurality of outer profiling elements, which are directed outwardly away from the track body.

The caterpillar track according to the invention is characterized in that the outer profiling element has an outwardly directed grouser body and a grouser root, which connects the grouser body to the track body, wherein the grouser body and the grouser root comprise different materials, preferably consist of different materials.

The conflict described above between the opposing requirements for the grouser body and the grouser root thereof can in this way be overcome according to the invention in that the materials can be respectively chosen or formed in such a way that they are designed as well as possible for the respective requirements. As a result, the lifetime and/or the load-bearing capacity of the caterpillar track can be improved.

The present invention is suitable in particular for being applied in the case of a method for producing rubber caterpillar tracks according to DE 10 2015 205 071 A1. The reason for this is that unvulcanized shaped elements that are intended to form the external teeth of the rubber caterpillar track are introduced there into corresponding apertures of the outer mold. Therefore, for easy and cost-effective implementation of the present invention, first the material that is intended to form the grouser body of the grouser may be introduced into the outer mold. Then the material that is intended to form the grouser root of the grouser may be introduced on top. Otherwise, the production method of DE 10 2015 205 071 A1 can remain unchanged. Alternatively, the blank of the grouser comprising the grouser body and the grouser root may first be constructed from the different materials and then placed as one piece into the outer mold.

It is advantageous here that, in the case of the method for producing rubber caterpillar tracks according to DE 10 2015 205 071 A1, a comparatively small displacement of the tension members occurs. Consequently, flow movements between the other layers of material and between the grouser body and the grouser root during the vulcanization can also be avoided comparatively well, and so the two different material regions of the grouser body and the grouser root can be positioned and separated from one another comparatively reliably and reproducibly. In this way it can be achieved that the properties of the two different materials of the grouser body and the grouser root can also be arranged and used at the locations where they are intended.

According to one aspect of the present invention, the grouser body comprises a material, preferably the grouser body consists of a material, which is more abrasion-resistant and/or can bring about better grip and/or can bring about better damping with respect to the underlying surface than the material of the grouser root. Preferably, the material of the grouser body may be more abrasion-resistant and/or cut-resistant than the material of the grouser root. Preferably, the material of the grouser body may alternatively or additionally have better damping and/or better grip with respect to the underlying surface, such as for example with respect to a road, than the material of the grouser root. This makes it possible to achieve at the grouser body the properties that are advantageous or required precisely at this location. Natural rubber, a mixture of natural rubber and styrene-butadiene rubber or a mixture of natural rubber and isoprene rubber may preferably be used as materials of the grouser body with such properties.

According to a further aspect of the present invention, the grouser root comprises a material, preferably the grouser root consists of a material, which has less heat build-up and/or a greater dynamic strength and or better bonding to the material of the track body than the material of the grouser body. This makes it possible to achieve at the grouser root the properties that are advantageous or required precisely at this location. Natural rubber with hardness-increasing fillers, such as for example carbon black or silica, may preferably be used as the material of the grouser root with such properties.

According to a further aspect of the present invention, the material of the grouser body and/or the material of the grouser root comprises or comprise an elastomeric material, preferably the material of the grouser body and/or the material of the grouser root consists or consist of an elastomeric material. As a result, the outer profiling element can have properties of an elastomeric material that may be advantageous for the applications of caterpillar tracks.

According to a further aspect of the present invention, a plurality of tension members, preferably steel cables, are embedded in the track body. As a result, forces can be transmitted substantially in the transverse direction and/or in the longitudinal direction by way of the tension members. In particular, as a result tensile forces can be transmitted in the longitudinal direction of the caterpillar track.

Preferably, the caterpillar track is of an endlessly closed form in the circumferential direction, i.e. in the running-around direction, or in the longitudinal direction. In this case, the caterpillar track may already be produced as endlessly closed or first be produced as open and then be endlessly closed.

An exemplary embodiment and further advantages of the invention are explained below in conjunction with the following FIGURE, in which:

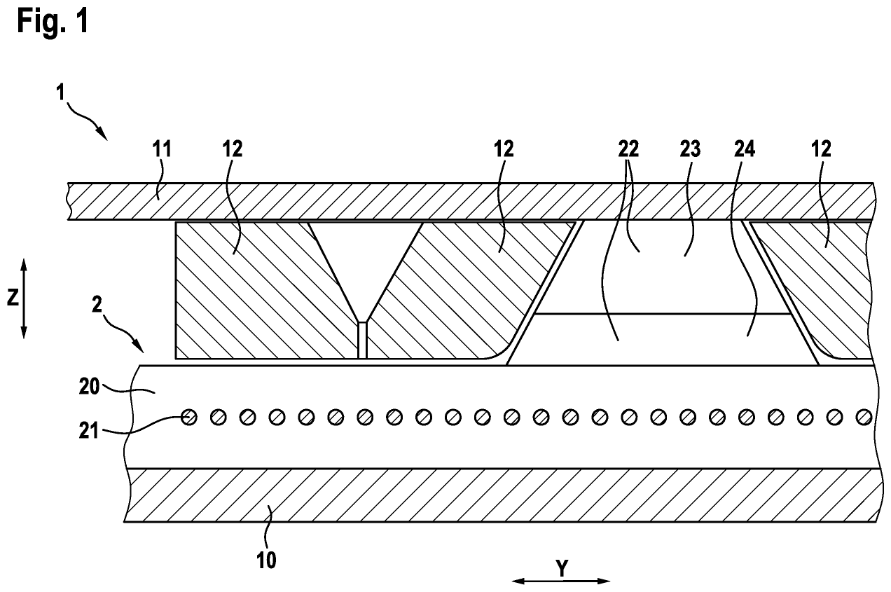

FIG. 1 shows a schematic cross section through a caterpillar track according to the invention in a production device prior to a vulcanization.

The description of FIG. 1 is given in Cartesian coordinates with a transverse direction Y and a vertical direction Z, which is aligned perpendicularly to the transverse direction Y and which may also be referred to as the height Z. In each case, a longitudinal direction is aligned perpendicularly thereto (not shown).

A caterpillar track 2 in the form of a rubber caterpillar track 2 is produced in an apparatus 1 for producing rubber caterpillar tracks 2 according to DE 10 2015 205 071 A1. The production apparatus 1 has an inner mold 10, an outer mold 11 and a plurality of grouser molds 12, which are formed and arranged as described in DE 10 2015 205 071 A1.

The rubber caterpillar track 2 is arranged between the inner mold 10, at the bottom in the vertical direction Z, and the outer mold 11 and the grouser molds 12, at the top in the vertical direction Z. The rubber caterpillar track 2 has a track body 20, which may also be referred to as a carcass 20. The track body 20 is arranged with its underside lying on the inner side or upper side of the inner mold 10. From above, the grouser molds 12 rest with their undersides on the upper side of the track body 20. Embedded within the track body 20 are a plurality of steel cables 21, which run in the longitudinal direction. Both the track body 20 and the steel cables 21 are endlessly closed in the longitudinal direction as the circumferential direction.

Directed outward, a plurality of outer profiling elements 22, which may also be referred to as external teeth 22 or grousers 22, rest on the upper side of the track body 20. The outer profiling elements 22 are respectively surrounded obliquely laterally in the transverse direction Y by the grouser molds 12 and from above by the outer mold 11.

According to the invention, the grousers 22 are formed from two different elastomeric materials. Thus, the grouser bodies 23, which form the upwardly projecting points of the grousers 22, comprise a comparatively abrasion-resistant material, which can also bring about a comparatively good grip with the underlying surface. By contrast to this, the grouser roots 24, which form the regions between the grouser bodies 23 and the track body 20, comprise a material which has less heat build-up, a greater dynamic strength and better bonding to the material of the track body 20 than the material of the grouser body 23. The conflicts between the opposing requirements for the grouser bodies 23 and the grouser roots 24 can in this way be overcome according to the invention in that the materials are respectively chosen or formed in such a way that they are designed as well as possible for the respective requirements. As a result, the lifetime and/or the load-bearing capacity of the rubber caterpillar track 2 can be improved.

### LIST OF REFERENCE DESIGNATIONS (PART OF THE DESCRIPTION)

Y transverse direction

Z vertical direction; height

1 production apparatus

10 inner mold

11 outer mold

12 grouser mold

2 (rubber) caterpillar track

20 track body; carcass

21 tension member; steel cables

22 outer profiling elements; external teeth; grousers

23 grouser body

24 grouser root

1.-5. (canceled)

6. A rubber caterpillar track comprising a track body having a plurality of outer profiling elements which are directed outwardly away from the track body, wherein each of the plurality of outer profiling elements comprises an outwardly directed grouser body and a grouser root, wherein the grouser root connects the grouser body to the track body, and wherein the grouser body and the grouser root comprise different materials.

7. The rubber caterpillar track as claimed in claim 6, wherein the grouser body and the grouser root consist of different materials.

8. The rubber caterpillar track as claimed in claim 6, wherein the grouser body comprises a material which provides one or more of higher abrasion-resistance, higher grip, and damping with respect to the underlying surface, in comparison to the material of the grouser root.

9. The rubber caterpillar track as claimed in claim 8, wherein the grouser body consists of a material which provides one or more of higher abrasion-resistance, higher grip, and damping with respect to the underlying surface, in comparison to the material of the grouser root.

10. The rubber caterpillar track as claimed in claim 6, wherein the grouser root comprises a material which provides one or more of less heat build-up, greater dynamic strength, and better bonding to the material of the track body, in comparison to the material of the grouser body.

11. The rubber caterpillar track as claimed in claim 10, wherein the grouser root consists of a material which provides one or more of less heat build-up, greater dynamic strength, and better bonding to the material of the track body, in comparison to the material of the grouser body.

12. The rubber caterpillar track as claimed in claim 6, wherein the material of the grouser body comprises an elastomeric material.

13. The rubber caterpillar track as claimed in claim 12, wherein the material of the grouser body consists of an elastomeric material.

14. The rubber caterpillar track as claimed in claim 6, wherein the material of the grouser root comprises an elastomeric material.

15. The rubber caterpillar track as claimed in claim 14, wherein the material of the grouser root consists of an elastomeric material.

16. The rubber caterpillar track as claimed in claim 6 further comprising a plurality of tension members embedded in the track body.

17. The rubber caterpillar track as claimed in claim 16, wherein the plurality of tension members are steel cables.

18. The rubber caterpillar track as claimed in claim 6, wherein the material comprised in the grouser body is selected from the group consisting of natural rubber, mixture of natural rubber and styrene-butadiene rubber, or mixture of natural rubber and isoprene rubber.

19. The rubber caterpillar track as claimed in claim 6, wherein the material comprised in the grouser root is natural rubber mixed with one or more of carbon black and silica.

20. A rubber caterpillar track comprising a track body having a plurality of outer profiling elements which are directed outwardly away from the track body, wherein each of the plurality of outer profiling elements comprises an outwardly directed grouser body and a grouser root, wherein the grouser root connects the grouser body to the track body;
wherein the material comprised in the grouser body is selected from the group consisting of natural rubber, mixture of natural rubber and styrene-butadiene rubber, or mixture of natural rubber and isoprene rubber;
wherein the material comprised in the grouser root is natural rubber mixed with one or more of carbon black and silica; and,
wherein the grouser body and the grouser root consist of different materials.

21. The rubber caterpillar track as claimed in claim 20, wherein the grouser body comprises a material which provides one or more of higher abrasion-resistance, higher grip, and damping with respect to the underlying surface, in comparison to the material of the grouser root.

22. The rubber caterpillar track as claimed in claim 20, wherein the grouser root comprises a material which provides one or more of less heat build-up, greater dynamic strength, and better bonding to the material of the track body, in comparison to the material of the grouser body.

23. The rubber caterpillar track as claimed in claim 20, wherein the grouser body comprises a material which provides one or more of higher abrasion-resistance, higher grip, and damping with respect to the underlying surface, in comparison to the material of the grouser root; and,
wherein the grouser root comprises a material which provides one or more of less heat build-up, greater dynamic strength, and better bonding to the material of the track body, in comparison to the material of the grouser body.

24. The rubber caterpillar track as claimed in claim 20 further comprising a plurality of tension members embedded in the track body.

25. The rubber caterpillar track as claimed in claim 24, wherein the plurality of tension members are steel cables.
